(19) United States
(12) Patent Application Publication
(10) Pub. No.: US 2012/0146521 A1
(43) Pub. Date: Jun. 14, 2012

(54) Method for Driving Light-Emitting Element and Method for Driving Light-Emitting Device

(75) Inventors: Tomoya Aoyama, Isehara (JP); Satoshi Seo, Sagamihara (JP); Takeru Sasaki, Isehara (JP)

(73) Assignee: Semiconductor Energy Laboratory Co., Ltd.

(21) Appl. No.: 13/314,785

(22) Filed: Dec. 8, 2011

(30) Foreign Application Priority Data
Dec. 10, 2010 (JP) 2010-275926

(51) Int. Cl. H05B 37/02

(52) U.S. Cl. 315/192; 315/307

(57) ABSTRACT

A method for driving a light-emitting element is provided with two steps: a first step of performing constant current drive; and a second step of increasing the absolute value of a voltage with time. It is assumed that a short circuit between a pair of electrodes occurs when a voltage which is applied to the light-emitting element is lower than or equal to the emission start voltage. A shift from the first step to the second step occurs when this condition is satisfied. Accordingly, a high current can be passed through a short-circuited portion between the pair of electrodes in the second step. The portion is insulated by heat (a short circuit between a pair of electrodes can be repaired), so that deterioration in the light-emitting element can be suppressed, and luminance of the light-emitting element can be recovered.

### BACKGROUND OF THE INVENTION

1. Field of the Invention

The present invention relates to a method for driving a light-emitting element, in particular, a light-emitting element which emits light with the use of organic electroluminescence. In addition, the present invention relates to a method for driving a light-emitting device having a light-emitting element which is driven by the driving method.

2. Description of the Related Art

In recent years, research and development of light-emitting elements using electroluminescence (hereinafter also referred to as EL) have been actively conducted. Such a light-emitting element has a structure where a layer including a light-emitting material is provided between a pair of electrodes. By voltage application between the pair of electrodes, light emission from the light-emitting material can be obtained.

A light-emitting element using electroluminescence has great features and advantages that it can be fabricated to be thin and lightweight and has very fast response speed, for example. There are a variety of possible applications of such a self-luminous light-emitting element. For example, such a light-emitting element is preferably used for a flat panel display because of having features such as higher pixel visibility as compared to a liquid crystal display and no need for backlight.

Since the light-emitting element can be formed in a film form, planar light emission from a large area can be readily obtained. This feature is difficult to obtain in point light sources typified by an incandescent lamp or a light-emitting diode (LED), or line light sources typified by a fluorescent lamp. Thus, the light-emitting element has a high utility value as a planar light source that can be applied to lighting and the like.

The light-emitting elements using electroluminescence are roughly classified in accordance with whether they include an organic compound or an inorganic compound as a light-emitting material. Now a principle of light emission of the light-emitting element which includes an organic compound as a light-emitting material will be described. First, by voltage application between a pair of electrodes of the light-emitting element, electrons and holes are separately injected from the, pair of electrodes into a layer including a light-emitting organic compound. Those carriers (the electrons and holes) are recombined, and then the light-emitting organic compound is excited. The light-emitting organic compound emits light when it returns to a ground state from the excited state.

An EL layer of a light-emitting element using electroluminescence is very thin. The EL layer is so thin that a pair of electrodes of the light-emitting element is easily short-circuited in the case where a conductive foreign substance enters between the pair of electrodes of the light-emitting element. The short circuit results in failures such as breakages of the light-emitting element, deterioration in the light-emitting element due to heat generation, and increase in power consumption due to a leakage current. In Patent Document 1, a method and a device for detecting short-circuited portions (defect portions) and for irradiating the portions (defect portions) with laser light so that the defect portions are insulated is proposed.

### REFERENCE

### Patent Document

[Patent Document 1] Japanese Published Patent Application No. 2002-260857

### SUMMARY OF THE INVENTION

A short circuit between a pair of electrodes of a light-emitting element may occur while the light-emitting element is emitting light, as well as in a process of manufacturing the light-emitting element. In the case where a short circuit between a pair of electrodes occurs while a light-emitting element is emitting light, heat generation at the short-circuited portion is promoted which results in deterioration in the light-emitting element. Further, when the light-emitting element is driven with a constant current, the flow of current concentrates on the short-circuited portion, which results in a decrease in luminance of the light-emitting element. Note that the method disclosed in Patent Document 1 is an effective method for repairing a short-circuited portion; however, it is difficult to use the method for repairing a short circuit between a pair of electrodes of a light-emitting element, which occurs while the light-emitting element is emitting light. In other words, it is difficult to use the method disclosed in Patent Document 1 for the light-emitting element or a light-emitting device having the light-emitting element after they are distributed to the market.

In view of the above problems, it is an object of one embodiment of the present invention to suppress deterioration in a light-emitting element. It is another object of one embodiment of the present invention to recover luminance of a light-emitting element, which is deceased while the light-emitting element is emitting light. It is a further another object of one embodiment of the present invention to provide a simple method for repairing a short circuit between a pair of electrodes of a light-emitting element. Note that one embodiment of the present invention aims to achieve at least one of the above objects.

The main point of a method for driving a light-emitting element of one embodiment of the present invention is to pass a high current through a short-circuited portion between a pair of electrodes so that the portion is insulated.

Specifically, one embodiment of the present invention is a method for driving a light-emitting element having a pair of electrodes at least one of which has a light-transmitting property, and a layer containing a light-emitting material, which is provided between the pair of electrodes. The method includes two steps: a first step of passing a constant or substantially constant driving current through the light-emitting element; and a second step of increasing the absolute value of a voltage applied to the light-emitting element with time. In the method, a shift from the first step to the second step occurs in the case where the voltage applied to the light-emitting element is lower than or equal to the emission start voltage in the first step.

Note that the emission start voltage in this specification is a voltage in which light emission of 1 cd/m² is observed from one of a pair of electrodes of the light-emitting element, which has a light-transmitting property.

A method for driving a light-emitting element of one embodiment of the present invention includes two steps: a first step of performing constant current drive; and a second step of increasing the absolute value of a voltage with time. Note that in the method for driving, a light-emitting element of one embodiment of the present invention, it is assumed that a short circuit between a pair of electrodes occurs when a voltage which is applied to the light-emitting element is lower than or equal to the emission start voltage. A shift from the first step to the second step occurs when this condition is satisfied. Accordingly, a high current can be passed through a short-circuited portion between the pair of electrodes in the second step. Thus, at least one of the pair of electrodes in the short-circuited portion can be melted and evaporated, or sublimated by heat generated by the high current. As a result, the portion can be insulated (the short circuit between the pair of electrodes can be repaired). That is, deterioration in the light-emitting element can be suppressed and luminance of the light-emitting element can be recovered.

Further, with the use of the method for driving a light-emitting element of one embodiment of the present invention, a short circuit between a pair of electrodes can be repaired by controlling a voltage applied to the light-emitting element. Thus, a short circuit between a pair of electrodes can be repaired simply as compared to the method disclosed in Patent Document 1.

### BRIEF DESCRIPTION OF THE DRAWINGS

In the accompanying drawings:

FIG. 1A is a structural example of a light-emitting element, FIG. 1B is a graph showing an example of variation of a voltage applied to a light-emitting element with time, FIG. 1C is a graph showing an example of variation of a current passed through a light-emitting element with time, FIG. 1D is an example of a short-circuited light-emitting element, and FIG. 1E is an example of an insulated light-emitting element;

FIG. 2 is a flow chart showing an example of a method for driving a light-emitting element;

FIGS. 3A and 3B are structural examples of light-emitting elements;

FIG. 4A is a graph showing an example of variation of a voltage applied to a light-emitting element with time and FIG. 4B is a graph showing an example of variation of a current passed through a light-emitting element with time;

FIG. 5 is a flow chart showing an example of a method for driving a light-emitting element;

FIGS. 6A and 6B are diagrams showing an example of a passive matrix light-emitting device;

FIGS. 7A and 7B are structural examples of a light-emitting device; and

FIGS. 8A and 8B are examples of an electric device.

### DETAILED DESCRIPTION OF THE INVENTION

Hereinafter, embodiments of the present invention will be described in detail with reference to the accompanying drawings. Note that the present invention is not limited to the description below, and it is easily understood by those skilled in the art that a variety of changes and modifications can be made without departing from the spirit and scope of the present invention. Thus, the present invention should not be limited to the descriptions in the following embodiments.

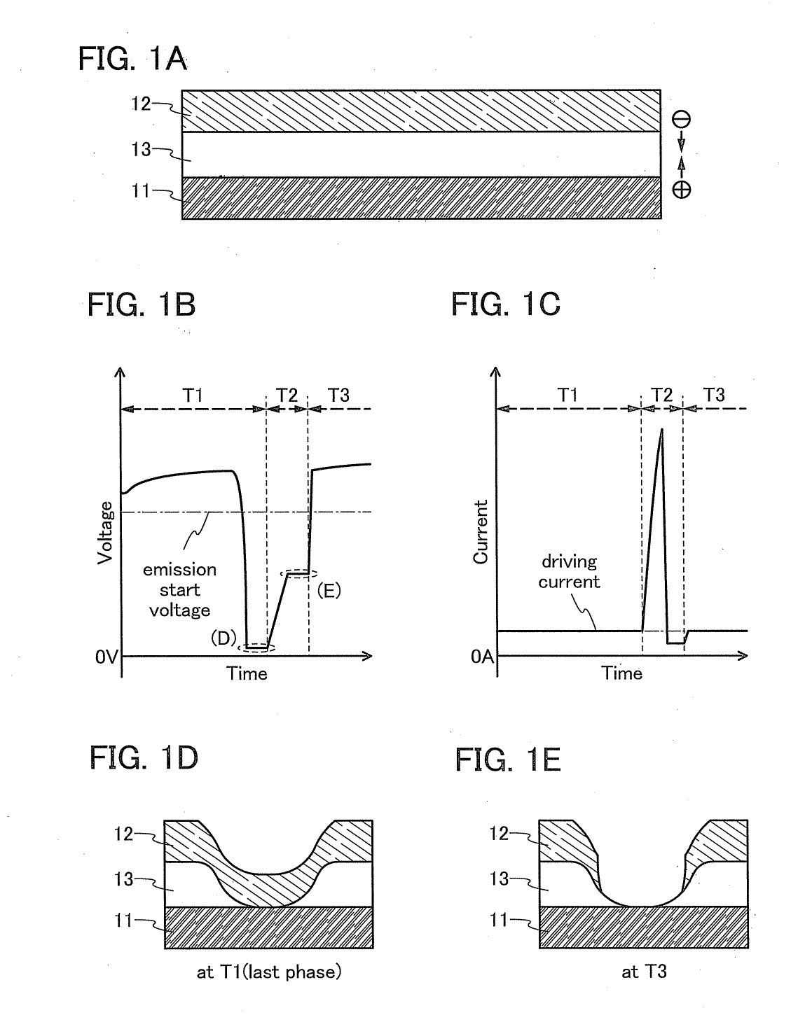

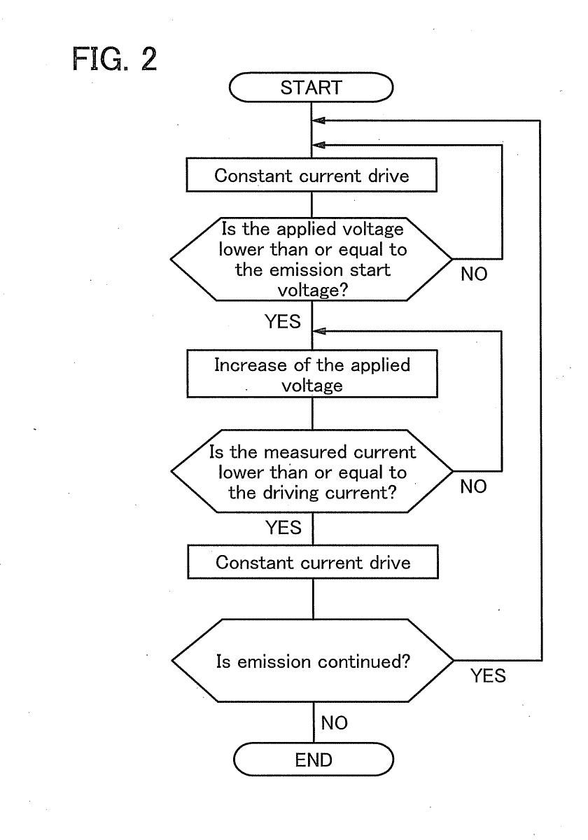

First, a light-emitting element according to one embodiment of the present invention and a method for driving the light-emitting element will be described with reference to FIGS. 1A to 1E and FIG. 2.

<Structural Example of Light-Emitting Element>

FIG. 1A is a structural example of a light-emitting element. The light-emitting element illustrated in FIG. 1A includes an anode 11, a cathode 12, and a layer 13 containing a light-emitting material, which is provided between the anode 11 and the cathode 12. Note that at least one of the anode 11 and the cathode 12 has a light-transmitting property.

When a voltage higher than the threshold voltage is applied between the anode 11 and the cathode 12, holes are injected from the anode 11 into the layer 13 containing a light-emitting material, and electrons are injected from the cathode 12 into the layer 13 containing a light-emitting material. The injected electrons and the injected holes are recombined at the layer 13 containing a light-emitting material, so that the light-emitting material emits light. The light is then emitted through at least one of the anode 11 and the cathode 12, which has a light-transmitting property.

The layer 13 containing a light-emitting material includes at least a light-emitting layer containing a light-emitting material, and may have a structure in which the light-emitting layer and a layer other than the light-emitting layer are stacked. Examples of the layer other than the light-emitting layer are layers containing a substance having a high hole-injection property, a substance having a high hole-transport property, a substance having a high electron-transport property, a substance having a high electron-injection property, a substance having a bipolar property (a substance having high electron-and-hole-transport properties), and the like. Specifically, a hole-injection layer, a hole-transport layer, a light-emitting layer, a hole-blocking layer, an electron-transport layer, an electron-injection layer, and the like are given, and they can be stacked as appropriate from the anode side.

<Example of Method for Driving Light-Emitting Element>

FIG. 1B is a graph showing variation of a voltage applied to a light-emitting element with time at the time of driving, and FIG. 1C is a graph showing variation of a current passed through a light-emitting element with time at the time of the driving. An example of the method for driving a light-emitting element, according to one embodiment of the present invention will be described below with reference to FIGS. 1B and 1C.

In a period T1, a voltage is controlled so that a constant or substantially constant driving current is passed through a light-emitting element (constant current drive). A value of the driving current may be set as appropriate in accordance with luminance of light emitted from the light-emitting element. That is, the driving current may be set at least higher than a current passed through the light-emitting element when the emission start voltage is applied to the light-emitting element. At this time, the voltage applied to the light-emitting element is higher than the emission start voltage.

Note that in some cases, the voltage applied to the light-emitting element is temporarily decreased in the initial stage of the period T1. This results from heat generation in the light-emitting element due to the driving current. Further, in some cases, the voltage applied to the light-emitting element is increased with time in the period T1. This results from deterioration in the light-emitting element with time.

When a short circuit between the anode 11 and the cathode 12 occurs as illustrated in FIG. 1D, the voltage applied to the light-emitting element is decreased to lower than or equal to the emission start voltage. In the method for driving a light-emitting element of one embodiment of the present invention, a shift to a period T2 occurs when a voltage applied to the light-emitting element is decreased to lower than or equal to the emission start voltage in the period T1.

In the period T2, the voltage applied to the light-emitting element is increased with time. At this time, a current passed through the light-emitting element is increased in proportion to the voltage applied to the light-emitting element. The current passed through the light-emitting element flows through a short-circuited portion between a pair of electrodes and thus, the portion locally generates heat. Accordingly, at least one of the pair of electrodes in the short-circuited portion can be melted and evaporated, or sublimated by heat generated by increasing the voltage applied to the light-emitting element with time. For example, part of the cathode 12, which is in the short-circuited portion can be sublimated as illustrated in FIG. 1E. As a result, the portion is insulated.

Further, due to the insulation of the portion, the current passed through the light-emitting element is decreased to lower than or equal to the driving current (current value at the time of constant current drive) in the period T1. In the method for driving a light-emitting element of one embodiment of the present invention, a shift to a period T3 occurs when the current passed through the light-emitting element is decreased to lower than or equal to the driving current in the period T2.

Note that although the voltage applied to the light-emitting element is increased linearly (the amount of change in voltage per unit time is made constant) in the period T2 as illustrated in FIGS. 1B and 1C, the voltage can be increased nonlinearly (the amount of change in voltage per unit time is made to vary).

In the period T3, constant current drive which is similar to that in the period T1 is performed.

An example of the method for driving a light-emitting element of one embodiment of the present invention will be described with reference to a flow chart in FIG. 2.

In the method for driving a light-emitting element of one embodiment of the present invention, light is emitted from the light-emitting element by constant current drive. At this time, a voltage applied to the light-emitting element at the time of the constant current drive is measured. Whether the constant current drive of the light-emitting element continues or shifts to driving in which applied voltage is increased is selected depending on whether a voltage value obtained by the voltage measurement is lower than or equal to the emission start voltage. Specifically, the constant current drive shifts to the driving in which applied voltage is increased when the voltage value obtained by the voltage measurement is lower than or equal to the emission start voltage, while the constant current drive continues when the voltage value is higher than the emission start voltage. Note that in the method for driving a light-emitting element of one embodiment of the present invention, the voltage can be measured constantly, regularly, or irregularly. As an example of the case where the voltage is measured irregularly, the voltage applied to the light-emitting element is measured with an operation by a user of the light-emitting element. In this case, the voltage applied to the light-emitting element can be measured when a reduction in luminance of the light-emitting element is visibly recognized by the user, for example.

In the case where the constant current drive shifts to driving in which applied voltage is increased, a current passed through the light-emitting element is measured. Whether the driving in which applied voltage is increased continues or shifts to the constant current drive is selected depending on whether a current value obtained by the current measurement is lower than or equal to the driving current. Specifically, the driving in which applied voltage is increased shifts to the constant current drive when the current value obtained by the current measurement is lower than or equal to the driving current, while the driving in which applied voltage is increased continues when the current value is higher than the driving current. Note that in the method for driving a light-emitting element of one embodiment of the present invention, the current can be measured constantly, regularly, or irregularly, after the shift to the driving in which applied voltage is increased. As an example of the case where the current is measured irregularly, the current passed through the light-emitting element is measured with an operation by a user of the light-emitting element. In this case, the current passed through the light-emitting element can be measured when recovery of luminance of the light-emitting element is visibly recognized by the user, for example.

Whether or not light continues to emit from the light-emitting element in which the constant current drive is performed can be selected as appropriate by the user.

The method for driving a light-emitting element of one embodiment of the present invention includes two steps: a step of performing constant current drive; and a step of performing driving in which applied voltage is increased. Note that whether or not a shift from the fowler step to the latter step occurs is determined by a voltage value applied to the light-emitting element. Specifically, it is assumed that a short circuit between a pair of electrodes occurs when a voltage which is applied to the light-emitting element is lower than or equal to the emission start voltage. A shift from the fowler step to the latter step occurs when this condition is satisfied. Accordingly, a high current can be passed through a short-circuited portion between the pair of electrodes in the step of performing driving in which applied voltage is increased. Thus, at least one of the pair of electrodes in the short-circuited portion can be melted and evaporated, or sublimated by heat generated by increasing the voltage applied to the light-emitting element with time. As a result, the portion can be insulated (the short circuit between the pair of electrodes can be repaired). That is, deterioration in the light-emitting element can be suppressed and luminance of the light-emitting element can be recovered.

Further, with the use of the method for driving a light-emitting element of one embodiment of the present invention, a short circuit between a pair of electrodes can be repaired by controlling a voltage applied to the light-emitting element. Thus, a short circuit between a pair of electrodes can be repaired simply as compared to the method disclosed in Patent Document 1.

<Modification Example>

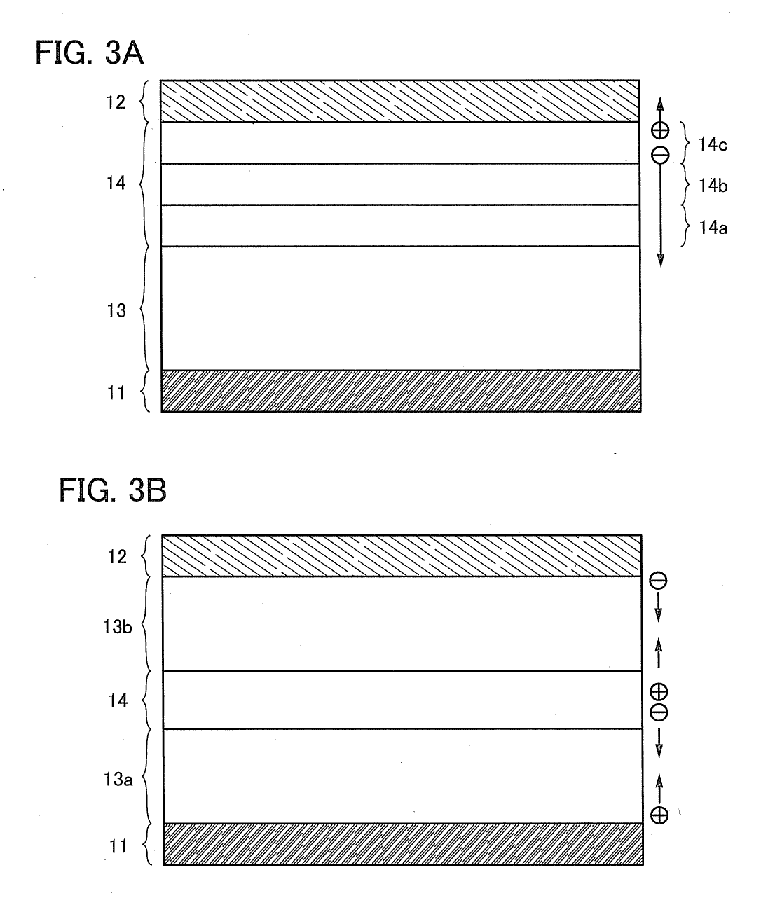

The above light-emitting element and the driving method thereof are one embodiment of the present invention. The present invention also includes a method for driving a light-emitting element with a structure different from the above light-emitting element and the driving method thereof. Modification examples of the above light-emitting element and the method for driving the above light-emitting element will be described below with reference to FIGS. 3A and 3B, FIGS. 4A and 4B, and FIG. 5.

(Modification Example 1 of Light-Emitting Element)

FIG. 3A is a structural example of a light-emitting element having a structure different from that of the light-emitting element illustrated in FIG. 1A. In the light-emitting element illustrated in FIG. 3A, the layer 13 containing a light-emitting material is provided between the anode 11 and the cathode 12. Further, an intermediate layer 14 is provided between the cathode 12 and the layer 13 containing a light-emitting material. Note that a structure similar to the layer 13 containing a light-emitting material included in the light-emitting element, which is illustrated in FIG. 1A can be applied to the layer 13 containing a light-emitting material included in the light-emitting element, which is illustrated in FIG. 3A. Thus, the description of the structural example of the light-emitting element can be referred to for the details.

The intermediate layer 14 includes at least a charge generation region, and may have a structure in which the charge generation region and a layer other than the charge generation region are stacked. For example, a structure can be employed in which a charge generation region 14c, an electron-relay layer 14b, and an electron-injection buffer 14a are stacked in this order from the cathode 12 side.

The behaviors of electrons and holes in the intermediate layer 14 will be described. When a voltage higher than the threshold voltage is applied between the anode 11 and the cathode 12, holes and electrons are generated in the charge generation region 14c, and the holes move into the cathode 12 and the electrons move into the electron-relay layer 14b. The electron-relay layer 14b has a high electron-transport property and immediately transfers the electrons generated in the charge generation region 14c to the electron-injection buffer 14a. The electron-injection buffer 14a can reduce a barrier to injection of electrons into the layer 13 containing a light-emitting material, and the efficiency of the electron injection into the layer 13 containing a light-emitting material can be improved. Thus, the electrons generated in the charge generation region 14c are injected into the LUMO level of the layer 13 containing a light-emitting material through the electron-relay layer 14b and the electron-injection buffer 14a.

In addition, the electron-relay layer 14b can prevent interaction in which a substance contained in the charge generation region 14c and a substance contained in the electron-injection buffer 14a react with each other at the interface thereof and the functions of the charge generation region 14c and the electron-injection buffer 14a are damaged, for example.

(Modification Example 2 of Light-Emitting Element)

FIG. 3B is a structural example of a light-emitting element having a structure different from that of the light-emitting elements illustrated in FIG. 1A and FIG. 3A. In the light-emitting element illustrated in FIG. 3B, layers 13a and 13b each containing a light-emitting material are provided between the anode 11 and the cathode 12. Further, the intermediate layer 14 is provided between the layer 13a containing a light-emitting material and the layer 13b containing a light-emitting material. Note that the number of the layers each containing a light-emitting material which are provided between the anode 11 and the cathode 12 is not limited to two. That is, a structure may be employed in which three or more layers each containing a light-emitting material are stacked between the anode 11 and the cathode 12, with an intermediate layer provided between the layers each containing a light-emitting material. Note that a structure similar to the layer 13 containing a light-emitting material included in the light-emitting element, which is illustrated in FIG. 1A can be applied to the layers 13a and 13b each containing a light-emitting material included in the light-emitting element, which is illustrated in FIG. 3B. In addition, a structure similar to the intermediate layer 14 included in the light-emitting element, which is illustrated in FIG. 3A can be applied to the intermediate layer 14 included in the light-emitting element, which is illustrated in FIG. 3B. Thus, the structural example of the light-emitting element and the modification example 1 of the light-emitting element can be referred to for the details.

The behaviors of electrons and holes in the intermediate layer 14 provided between the layers each containing a light-emitting material will be described. When a voltage higher than the threshold voltage is applied between the anode 11 and the cathode 12, holes and electrons are generated in the intermediate layer 14, and the holes move into the layer 13b containing a light-emitting material which is provided on the cathode 12 side and the electrons move into the layer 13a containing a light-emitting material which is provided on the anode 11 side. The holes injected into the layer 13b containing a light-emitting material are recombined with the electrons injected from the cathode 12 side, so that the light-emitting material emits light. The electrons injected into the layer 13a containing a light-emitting material are recombined with the holes injected from the anode 11 side, so that the light-emitting material emits light. Thus, the holes and electrons generated in the intermediate layer 14 cause light emission in the respective layers each containing a light-emitting material.

Note that in the case where a structure which is the same as an intermediate layer is formed between the layers each containing a light-emitting material by providing the layers each containing a light-emitting material that are in contact with each other, the layers each containing a light-emitting material can be formed to be in contact with each other. Specifically, when a charge generation region is formed on one surface of the layer containing a light-emitting material, the charge generation region functions as a charge generation region of an intermediate layer; thus, the layers each containing a light-emitting material can be formed in contact with each other.

The structural example of the light-emitting element and the modification examples 1 and 2 of the light-emitting element can be implemented in combination. For example, an intermediate layer may be provided between the cathode 12 and the layer 13b containing a light-emitting material in the modification example 2 of the light-emitting element.

(Modification Example 1 of Method for Driving Light-Emitting Element)

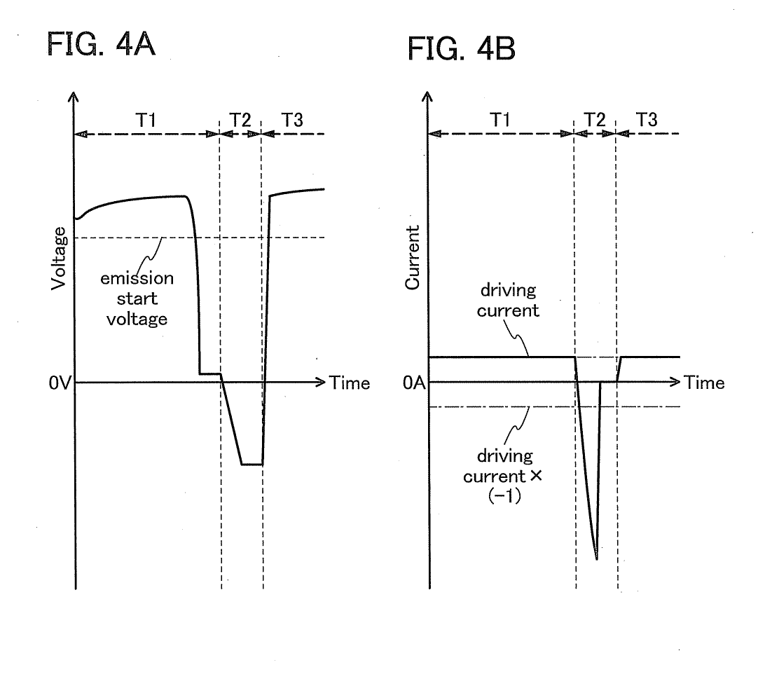

FIG. 4A is a graph showing variation of a voltage applied to a light-emitting element with time at the time of driving, which is different from FIG. 1C, and FIG. 4B is a graph showing variation of a current passed through a light-emitting element with time at the time of the driving. Specifically, FIG. 4A differs from FIG. 1B in that a reverse bias voltage which increases with time is applied to a light-emitting element in the period T2. In the case where a reverse bias voltage is applied in the period T2, a current can be passed only through a short-circuited portion between a pair of electrodes included in a light-emitting element. That is, in the case where a forward bias voltage is applied in the period T2 in FIG. 1B, a high current is passed through a layer containing a light-emitting material included in the light-emitting element and there is a possibility that deterioration in the light-emitting element is increased, whereas there is no such possibility in the case where a reverse bias voltage is applied. Thus, a driving method in which a reverse bias voltage can be applied in the period T2 is preferable because deterioration in the light-emitting element in the period T2 can be suppressed. Note that a bias voltage is a voltage other than a driving voltage.

Note that in a driving method in which a reverse bias voltage can be applied as shown in FIGS. 4A and 4B, when the absolute value of a current passed through a light-emitting element is changed from a value higher than a driving current to a value lower than a driving current, a shift from the period T2 (a step of applying a reverse bias voltage which increases with time to a light-emitting element) to the period T3 (a step of performing constant current drive) can occur, for example. Note that the current passed through the light-emitting element can be measured constantly, regularly, or irregularly. However, in the driving method in which a reverse bias voltage is applied as shown in FIGS. 4A and 4B, luminance is not recovered even when a short circuit between a pair of electrodes is repaired. Thus, whether the short circuit is repaired or not is hardly determined visually by a user. Accordingly, when the current is measured with an operation by a user, the case where a light-emitting element is driven in accordance with the variation with time as shown in FIGS. 1B and 1C (a case where a forward bias voltage which increases with time is applied to a light-emitting element in the period T2) is preferable.

(Modification Example 2 of Method for Driving Light-Emitting Element)

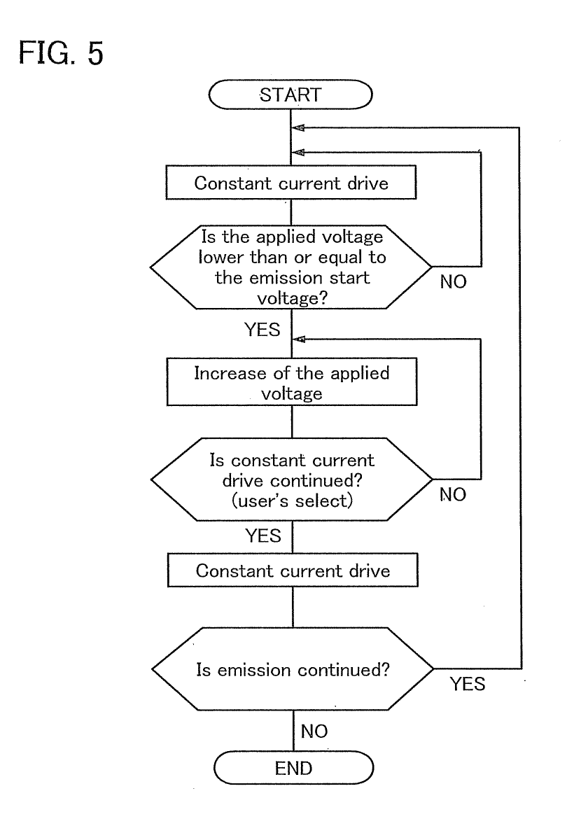

FIG. 5 is a flow chart showing a method for driving a light-emitting element, which is different from the flow chart in FIG. 2. Specifically, the flow chart in FIG. 5 differs from the flow chart in FIG. 2 in that a shift from the step of performing driving in which applied voltage is increased to the step of performing constant current drive is controlled with an operation by a user. In the method for driving a light-emitting element, according to one embodiment of the present invention, the shift can depend solely on an operation by a user.

<Specific Example of Light-Emitting Element>

Next, specific materials that can be used for the light source having the above structure will be described. Materials for the anode 11, the cathode 12, the layer 13 containing a light-emitting material, the charge generation region 14c, the electron-relay layer 14b, and the electron-injection buffer 14a will be described in this order.

(Material for Anode 11)

The anode 11 is preferably fowled using a metal, an alloy, an electrically conductive compound, a mixture of these materials, or the like which has a high work function (specifically, a work function of 4.0 eV or higher is preferable). Specific examples are given below: indium tin oxide (ITO), indium tin oxide containing silicon or silicon oxide, indium zinc oxide (IZO), and indium oxide containing tungsten oxide and zinc oxide.

Such conductive metal oxide films are usually formed by a sputtering method, but may be formed by application of a sol-gel method or the like. For example, a film of indium zinc oxide (IZO) can be formed by a sputtering method using a target in which zinc oxide is added to indium oxide at 1 to 20 wt %. A film of indium oxide containing tungsten oxide and zinc oxide can be formed by a sputtering method using a target in which tungsten oxide and zinc oxide are added to indium oxide at 0.5 to 5 wt % and 0.1 to 1 wt %, respectively.

Besides, as a material used for the anode 11, the following can be given: gold (Au), platinum (Pt), nickel (Ni), tungsten (W), chromium (Cr), molybdenum (Mo), iron (Fe), cobalt (Co), copper (Cu), palladium (Pd), titanium (Ti), nitride of a metal material (e.g., titanium nitride), a molybdenum oxide, a vanadium oxide, a ruthenium oxide, a tungsten oxide, a manganese oxide, a titanium oxide, and the like. Alternatively, a conductive polymer such as poly(3,4-ethylenedioxythiophene)/poly(styrenesulfonic acid) (PEDOT/PSS) or polyaniline/poly(styrenesulfonic acid) (PAni/PSS) may be used.

Note that in the case where the charge generation region is provided in contact with the anode 11, a variety of conductive materials can be used for the anode 11 regardless of their work functions. Specifically, besides a material which has a high work function, a material which has a low work function can also be used for the anode 11.

(Material for Cathode 12)

In the case where the charge generation region is provided between the cathode 12 and the layer 13 containing a light-emitting material to be in contact with the cathode 12, a variety of conductive materials can be used for the cathode 12 regardless of their work functions.

Note that at least one of the cathode 12 and the anode 11 is formed using a conductive film having a light-transmitting property. For the conductive film having a light-transmitting property, the following can be given: an indium oxide containing tungsten oxide, an indium zinc oxide containing tungsten oxide, an indium oxide containing titanium oxide, an indium tin oxide containing titanium oxide, an indium tin oxide, an indium zinc oxide, an indium tin oxide to which silicon oxide is added, and the like. Alternatively, a metal thin film having a thickness enough to transmit light (preferably, approximately 5 nm to 30 nm) can also be used.

(Material for Layer 13 Containing Light-Emitting Material)

Specific examples of the material for the layers included in the above layer 13 containing a light-emitting material will be described below.

The hole-injection layer is a layer containing a substance having a high hole-injection property. As the substance having a high hole-injection property, for example, a molybdenum oxide, a vanadium oxide, a ruthenium oxide, a tungsten oxide, a manganese oxide, or the like can be used. In addition, it is possible to use a phthalocyanine-based compound such as phthalocyanine (abbreviation: H₂Pc) or copper phthalocyanine (abbreviation: CuPc), a high molecule such as poly(3,4-ethylenedioxythiophene)/poly(styrenesulfonic acid) (PEDOT/PSS), or the like to form the hole-injection layer.

Note that the hole-injection layer may be formed using the charge generation region. When the charge generation region is used for the hole-injection layer, a variety of conductive materials can be used for the anode 11 regardless of their work functions as described above.

The hole-transport layer is a layer containing a substance having a high hole-transport property. As the substance having a high hole-transport property, the following can be given, for example: aromatic amine compounds such as 4,4′-bis[N-(1-naphthyl)-N-phenylamino]biphenyl (abbreviation: NPB or α-NPD), N,N′-bis(3-methylphenyl)-N,N′-diphenyl-[1,1′-biphenyl]-4,4′-diamine (abbreviation: TPD), 4-phenyl-4′-(9-phenylfluoren-9-yl)triphenylamine (abbreviation: BPAFLP), 4,4′,4″-tris(carbazol-9-yl)triphenylamine (abbreviation: TCTA), 4,4′,4″-tris(N,N-diphenylamino)triphenylamine (abbreviation: TDATA), 4,4′,4″-tris[N-(3-methylphenyl)-N-phenylamino]triphenylamine (abbreviation: MTDATA), and 4,4′-bis[N-(spiro-9,9′-bifluorene-2-yl)-N-phenylamino]biphenyl (abbreviation: BSPB); 3-[N-(9-phenylcarbazol-3-yl)-N-phenylamino]-9-phenylcarbazole (abbreviation: PCzPCA1); 3,6-bis[N-(9-phenylcarbazol-3-yl)-N-phenylamino]-9-phenylcarbazole (abbreviation: PCzPCA2); 3-[N-(1-naphthyl)-N-(9-phenylcarbazol-3-yl)amino]-9-phenylcarbazole (abbreviation: PCzPCN1); and the like. Alternatively, any of the following carbazole derivatives can be used: 4,4′-di(N-carbazolyl)biphenyl (abbreviation: CBP), 1,3,5-tris[4-(N-carbazolyl)phenyl]benzene (abbreviation: TCPB), 9-[4-(10-phenyl-9-anthracenyl)phenyl]-9H-carbazole (abbreviation: CzPA), and the like. The substances mentioned here are mainly ones that have a hole mobility of 10⁻⁶ cm²/Vs or higher. However, any substance other than the above materials may also be used as long as the substance has a higher hole-transport property than an electron-transport property. The layer containing a substance having a high hole-transport property is not limited to a single layer, and two or more layers containing the aforementioned substances may be stacked.

In addition to the above substances, a high molecular compound such as poly(N-vinylcarbazole) (abbreviation: PVK), poly(4-vinyltriphenylamine) (abbreviation: PVTPA), poly[N-(4-{N′-[4-(4-diphenylamino)phenyl]phenyl-N′-phenylamino}phenyl)methacryla mide] (abbreviation: PTPDMA), or poly[N,N′-bis(4-butylphenyl)-N,N′-bis(phenyl)benzidine] (abbreviation: Poly-TPD) can be used for the hole-transport layer.

The light-emitting layer is a layer containing a light-emitting material. As the light-emitting material, any of the following fluorescent compounds can be used. For example, the following can be given:

N,N′-bis[4-(9H-carbazol-9-yl)phenyl]-N,N′-diphenylstilbene-4,4′-diamine; 4-(9H-carbazol-9-yl)-4′-(10-phenyl-9-anthryl)triphenylamine; 4-(9H-carbazol-9-yl)-4′-(9,10-diphenyl-2-anthryl)triphenylamine; N,9-diphenyl-N-[4-(10-phenyl-9-anthryl)phenyl]-9H-carbazol-3-amine (abbreviation: PCAPA); perylene; 2,5,8,11 -tetra-tert-butylperylene (abbreviation: TBP); 4-(10-phenyl-9-anthryl)-4′-(9-phenyl-9H-carbazol-3-yl)triphenylamine (abbreviation: PCBAPA);

N,N″-(2-tert-butylanthracene-9,10-diyldi-4,1-phenylene)bis[N,N′,N′-triphenyl-1,4-pheny lenediamine] (abbreviation: DPABPA); N,9-diphenyl-N-[4-(9,10-diphenyl-2-anthryl)phenyl]-9H-carbazol-3-amine (abbreviation: 2PCAPPA); N-[4-(9,10-diphenyl-2-anthryl)phenyl]-N,N′,N′-triphenyl-1,4-phenylenediamine (abbreviation: 2DPAPPA); N,N,N′,N′,N″,N″,N′″,N′″-octaphenyldibenzo[g,p]chrysene-2,7,10,15-tetraamine (abbreviation: DBC1); coumarin 30; N-(9,10-diphenyl-2-anthryl)-N,9-diphenyl-9H-carbazol-3-amine (abbreviation: 2PCAPA);

N-[9,10-bis(1,1′-biphenyl-2-yl)-2-anthryl]-N,9-diphenyl-9H-carbazol-3-amine (abbreviation: 2PCABPhA); N-(9,10-diphenyl-2-anthryl)-N,N′,N′-triphenyl-1,4-phenylenediamine (abbreviation: 2DPAPA);

N-[9,10-bis(1,1′-biphenyl-2-yl)-2-anthryl]-N,N′,N′-triphenyl-1,4-phenylenediamine (abbreviation: 2DPABPhA); 9,10-bis(1,1′-biphenyl-2-yl)-N-[4-(9H-carbazol-9-yl)phenyl]-N-phenylanthracen-2-amine; N,N,9-triphenylanthracen-9-amine (abbreviation: DPhAPhA); coumarin 545T; N,N′-diphenylquinacridone (abbreviation: DPQd); rubrene; 5,12-bis(1,1′-biphenyl-4-yl)-6,11-diphenyltetracene (abbreviation: BPT); 2-(2-{2-[4-(dimethylamino)phenyl]ethenyl}-6-methyl-4H-pyran-4-ylidene)propanedinit rile (abbreviation: DCM1); 2-{2-methyl-6-[2-(2,3,6,7-tetrahydro-1H,5H-benzo[ij]quinolizin-9-yl)ethenyl]-4H-pyran-4-ylidene}propanedinitrile (abbreviation: DCM2); N,N,N′,N′-tetrakis(4-methylphenyl)tetracene-5,11-diamine (abbreviation: p-mPhTD); 7,14-diphenyl-N,N,N′,N′-tetrakis(4-methylphenyl)acenaphtho[1,2-a]fluoranthene-3,10-d iamine (abbreviation: p-mPhAFD); 2-{2-isopropyl-6-[2-(1,1,7,7-tetramethyl-2,3,6,7-tetrahydro-1H,5H-benzo[ij]quinolizin-9-yl)ethenyl]-4H-pyran-4-ylidene}propanedinitrile (abbreviation: DCJTI); 2-{2-tent-butyl-6-[2-(1,1,7,7-tetramethyl-2,3,6,7-tetrahydro-1H,5H-benzo[ij]quinolizin-9-yl)ethenyl]-4H-pyran-4-ylidene} propanedinitrile (abbreviation: DCJTB); 2-(2,6-bis{2-[4-(dimethylamino)phenyl]ethenyl}-4H-pyran-4-ylidene)propanedinitrile (abbreviation: BisDCM); 2-{2,6-bis[2-(8-methoxy-1,1,7,7-tetramethyl-2,3,6,7-tetrahydro-1H,5H-benzo[ij]quinoli zin-9-yl)ethenyl]-4H-pyran-4-ylidene}propanedinitrile (abbreviation: BisDCJTM); and SD1 (product name; manufactured by SFC Co., Ltd).

As the light-emitting material, any of the following phosphorescent compounds can also be used. For example, the following can be given: bis[2-(4′,6′-difluorophenyl)pyridinato-N,C^{2′}]iridium(III)tetrakis(1-pyrazolyl)borate (abbreviation: FIr6); bis[2-(4′,6′-difluorophenyl)pyridinato-N,C^{2′}]iridium(III)picolinate (abbreviation: FIrpic); bis[2-(3′,5′-bistrifluoromethylphenyl)pyridinato-N,C^{2′}]iridium(III)picolinate (abbreviation: Ir(CF₃ppy)₂(pic)); bis[2-(4′,6′-difluorophenyl)pyridinato-N,C^{2′}]iridium(III) acetylacetonate (abbreviation: FIracac); tris(2-phenylpyridinato)iridium(III) (abbreviation: Ir(ppy)₃); bis(2-phenylpyridinato)iridium(III)acetylacetonato (abbreviation: Ir(ppy)₂(acac)); bis(benzo[h]quinolinato)iridium(III)acetylacetonate (abbreviation: Ir(bzq)₂(acac)); bis(2,4-diphenyl-1,3-oxazolato-N,C^{2′})iridium(III)acetylacetonate (abbreviation: Ir(dpo)₂(acac)); bis[2-(4′-perfluorophenylphenyl)pyridinato]iridium(III)acetylacetonate (abbreviation: Ir(p-PF-ph)₂(acac)); bis(2-phenylbenzothiazolato-N,C^{2′})iridium(III)acetylacetonate (abbreviation: Ir(bt)₂(acac)); bis[2-(2′-benzo[4,5-α]thienyl)pyridinato-N,C^{3′}]iridium(III) acetylacetonate (abbreviation: Ir(btp)₂(acac)); bis(1-phenylisoquinolinato-N,C^{2′})iridium(III)acetylacetonate (abbreviation: Ir(piq)₂(acac)); (acetylacetonato)bis[2,3-bis(4-fluorophenyl)quinoxalinato]iridium(III) (abbreviation: Ir(Fdpq)₂(acac)); (acetylacetonato)bis(2,3,5-triphenylpyrazinato)iridium(III) (abbreviation: Ir(tppr)₂(acac)); 2,3,7,8,12,13,17,18-octaethyl-21H,23H-porphyrin platinum(II) (abbreviation: PtOEP); tris(acetylacetonato)(monophenanthroline)terbium(III) (abbreviation: Tb(acac)₃(Phen)); tris(1,3-diphenyl-1,3-propanedionato)(monophenanthroline)europium(III) (abbreviation: Eu(DBM)₃(Phen)); tris[1-(2-thenoyl)-3,3,3-trifluoroacetonato](monophenanthroline)europium(III) (abbreviation: Eu(TTA)₃(Phen)); and (dipivaloylmethanato)bis(2,3,5-triphenylpyrazinato)iridium(III) (abbreviation: Ir(tppr)₂(dpm)).

Note that those light-emitting materials are preferably dispersed in a host material. As the host material, for example, the following can be used: an aromatic amine compound such as NPB (abbreviation), TPD (abbreviation), TCTA (abbreviation), TDATA (abbreviation), MTDATA (abbreviation), or BSPB (abbreviation); a carbazole derivative such as PCzPCA1 (abbreviation), PCzPCA2 (abbreviation); PCzPCN1 (abbreviation), CBP (abbreviation), TCPB (abbreviation), CzPA (abbreviation), 9-phenyl-3-[4-(10-phenyl-9-anthryl)phenyl]-9H-carbazole (abbreviation: PCzPA), or 4-phenyl-4′-(9-phenyl-9H-carbazol-3-yl)triphenylamine (abbreviation: PCBA1BP); a substance having a high hole-transport property, which contains a high molecular compound, such as PVK (abbreviation), PVTPA (abbreviation), PTPDMA (abbreviation), or Poly-TPD (abbreviation); a metal complex having a quinoline skeleton or a benzoquinoline skeleton, such as tris(8-quinolinolato)aluminum (abbreviation: Alq), tris(4-methyl-8-quinolinolato)aluminum (abbreviation: Almq₃), bis(10-hydroxybenzo[h]quinolinato)beryllium (abbreviation: BeBq₂), or bis(2-methyl-8-quinolinolato)(4-phenylphenolato)aluminum (abbreviation: BAlq); a metal complex having an oxazole-based or thiazole-based ligand, such as bis[2-(2-hydroxyphenyl)benzoxazolato]zinc (abbreviation: Zn(BOX)₂) or bis[2-(2-hydroxyphenyl)benzothiazolato]zinc (abbreviation: Zn(BTZ)₂); or a substance having a high electron-transport property, such as 2-(4-biphenylyl)-5-(4-teat-butylphenyl)-1,3,4-oxadiazole (abbreviation: PBD), 1,3-bis[5-(p-tert-butylphenyl)-1,3,4-oxadiazol-2-yl]benzene (abbreviation: OXD-7), 9-[4-(5-phenyl-1,3,4-oxadiazol-2-yl)phenyl]-9H-carbazole (abbreviation: CO11), 3-(4-biphenylyl)-4-phenyl-5-(4-tert-butylphenyl)-1,2,4-triazole (abbreviation: TAZ), bathophenanthroline (abbreviation: BPhen), or bathocuproine (abbreviation: BCP).

The electron-transport layer is a layer containing a substance having a high electron-transport property. As the substance having a high electron-transport property, for example, a metal complex having a quinoline skeleton or a benzoquinoline skeleton, such as Alq (abbreviation), Almq₃ (abbreviation), BeBq₂ (abbreviation), or BAlq (abbreviation) can be used. In addition to the above, a metal complex having an oxazole-based or thiazole-based ligand, such as Zn(BOX)₂ (abbreviation) or Zn(BTZ)₂ (abbreviation) can also be used. Further, besides the metal complex, PBD (abbreviation), OXD-7 (abbreviation), CO11 (abbreviation), TAZ (abbreviation), BPhen (abbreviation), BCP (abbreviation), 2[4-(dibenzothiophen-4-yl)phenyl]-1 -phenyl-1H-benzimidazole (abbreviation: DBTBIm-II), or the like can also be used. The substances mentioned here are mainly ones that have an electron mobility of 10⁻⁶ cm²Ns or higher. Note that any substance other than the above materials may be used as long as the substance has a higher electron-transport property than a hole-transport property. The electron-transport layer is not limited to a single layer, and two or more layers containing the aforementioned substances may be stacked.

Alternatively, a high molecular compound such as poly[(9,9-dihexylfluorene-2,7-diyl)-co-(pyridine-3,5-diyl)] (abbreviation: PF-Py), poly[(9,9-dioctylfluorene-2,7-diyl)-co-(2,2′-bipyridine-6,6′-diyl)] (abbreviation: PF-BPy), or the like can be used for the electron-transport layer.

The electron-injection layer is a layer containing a substance having a high electron-injection property. As the substance having a high electron-injection property, the following can be given, for example: an alkali metal, an alkaline earth metal, and compound thereof, such as lithium (Li), cesium (Cs), calcium (Ca), lithium fluoride (LiF), cesium fluoride (CsF), and calcium fluoride (CaF₂). Alternatively, a layer containing a substance having an electron-transport property and an alkali metal, an alkaline earth metal, or a compound thereof (e.g., Alq containing magnesium (Mg)) can be used. Such a structure makes it possible to improve the efficiency of the electron injection from the cathode 12.

As a method for forming the layer 13 containing a light-emitting material by combining these layers as appropriate, any of a variety of methods (e.g., a dry process and a wet process) can be selected as appropriate. For example, a vacuum evaporation method, an inkjet method, a spin coating method, or the like may be selected in accordance with a material to be used. Note that a different formation method may be employed for each layer.

(Material for Charge Generation Region 14c)

The charge generation region 14c is a region containing a substance having a high hole-transport property and an acceptor substance. The charge generation region 14c is not limited to a structure in which a substance having a high hole-transport property and an acceptor substance are contained in the same film, and may have a structure in which a layer containing a substance having a high hole-transport property and a layer containing an acceptor substance are stacked. Note that in the case of a stacked-layer structure in which the charge generation region is provided on the cathode 12 side, the layer containing a substance having a high hole-transport property is in contact with the cathode 12, and in the case of a stacked-layer structure in which the charge generation region is provided on the anode 11 side, the layer containing an acceptor substance is in contact with the anode 11.

Note that the acceptor substance is preferably added to the charge generation region 14c so that the mass ratio of the acceptor substance to the substance having a high hole-transport property is greater than or equal to 0.1:1 and less than or equal to 4.0:1.

As the acceptor substance used for the charge generation region 14c, a transition metal oxide and an oxide of a metal belonging to Groups 4 to 8 of the periodic table can be given. Specifically, molybdenum oxide is particularly preferable. Note that molybdenum oxide has a low hygroscopic property.

As the substance having a high hole-transport property used for the charge generation region 14c, any of a variety of organic compounds such as an aromatic amine compound, a carbazole derivative, an aromatic hydrocarbon, and a high molecular compound (such as an oligomer, a dendrimer, or a polymer) can be used. Specifically, a substance having a hole mobility of 10⁻⁶ cm²/Vs or higher is preferably used. However, any substance other than the above materials may be used as long as the substance has a higher hole-transport property than an electron-transport property.

(Material for Electron-Relay Layer 14b)

The electron-relay layer 14b is a layer that can immediately receive electrons drawn out by the acceptor substance in the charge generation region 14c. Thus, the electron-relay layer 14b is a layer containing a substance having a high electron-transport property, and the LUMO level thereof is located between the acceptor level of the acceptor substance in the charge generation region 14c and the LUMO level of the layer 13 containing a light-emitting material. Specifically, the LUMO level of the electron-relay layer 14b is preferably about greater than or equal to −5.0 eV and less than or equal to −3.0 eV.

As the substance used for the electron-relay layer 14b, a perylene derivative and a nitrogen-containing condensed aromatic compound can be given. Note that a nitrogen-containing condensed aromatic compound is preferably used for the electron-relay layer 14b because of its stability. Among nitrogen-containing condensed aromatic compounds, a compound having an electron-withdrawing group such as a cyano group or a fluoro group is preferably used because such a compound further facilitates reception of electrons in the electron-relay layer 14b.

As specific examples of the perylene derivative, the following can be given: 3,4,9,10-perylenetetracarboxylic dianhydride (PTCDA), 3,4,9,10-perylenetetracarboxylic-bis-benzimidazole (PTCBI), N,N′-dioctyl-3,4,9,10-perylenetetracarboxylic diimide (PTCDI-C8H), N,N′-dihexyl-3,4,9,10-perylenetetracarboxylic diimide (Hex PTC), and the like.

As specific examples of the nitrogen-containing condensed aromatic compound, the following can be given: pirazino[2,3-f][1,10]phenanthroline-2,3-dicarbonitrile (PPDN), 2,3,6,7,10,11-hexacyano-1,4,5,8,9,12-hexaazatriphenylene (HAT(CN)₆), 2,3-diphenylpyrido[2,3-b]pyrazine (2PYPR), 2,3-bis(4-fluorophenyl)pyrido[2,3-b]pyrazine (F2PYPR), and the like.

Besides, 7,7,8,8-tetracyanoquinodimethane (abbreviation: TCNQ), 1,4,5,8-naphthalenetetracarboxylic dianhydride (abbreviation: NTCDA), perfluoropentacene, copper hexadecafluorophthalocyanine (abbreviation: F₁₆CuPc), N,N′-bis(2,2,3,3,4,4,5,5,6,6,7,7,8,8,8-pentadecafluorooctyl)-1,4,5,8-naphthalenetetracar boxylic diimide (abbreviation: NTCDI-C8F), 3′,4′-dibutyl-5,5″-bis(dicyanomethylene)-5,5″-dihydro-2,2′:5′,2″-terthiophene (abbreviation: DCMT), methanofullerenes (e.g., [6,6]-phenyl C₆₁ butyric acid methyl ester), or the like can be used for the electron-relay layer 14b.

(Material for Electron-Injection Buffer 14a)

The electron-injection buffer 14a is a layer which facilitates electron injection from the charge generation region 14c into the layer 13 containing a light-emitting material. The provision of the electron-injection buffer 14a between the charge generation region 14c and the layer 13 containing a light-emitting material makes it possible to reduce the injection barrier therebetween.

A substance having a high electron-injection property can be used for the electron-injection buffer 14a. For example, an alkali metal, an alkaline earth metal, a rare earth metal, a compound thereof (e.g., an alkali metal compound (including an oxide such as lithium oxide, a halide, and a carbonate such as lithium carbonate or cesium carbonate), an alkaline earth metal compound (including an oxide, a halide, and a carbonate), or a rare earth metal compound (including an oxide, a halide, and a carbonate)) can be used.

Further, in the case where the electron-injection buffer 14a contains a substance having a high electron-transport property and a donor substance, the donor substance is preferably added so that the mass ratio of the donor substance to the substance having a high electron-transport property is greater than or equal to 0.001:1 and less than or equal to 0.1:1. Note that as the donor substance, an organic compound such as tetrathianaphthacene (abbreviation: TTN), nickelocene, or decamethylnickelocene can be used as well as an alkali metal, an alkaline earth metal, a rare earth metal, a compound thereof (e.g., an alkali metal compound (including an oxide such as lithium oxide, a halide, and a carbonate such as lithium carbonate or cesium carbonate), an alkaline earth metal compound (including an oxide, a halide, and a carbonate), and a rare earth metal compound (including an oxide, a halide, and a carbonate)). Note that as the substance having a high electron-transport property, a material similar to the above material for the electron-transport layer which can be formed in part of the layer 13 containing a light-emitting material can be used.

The light-emitting element can be fabricated by combination of the above materials. Light emission from the above light-emitting material can be obtained with this light-emitting element, and the emission color can be selected by changing the type of the light-emitting material. Further, a plurality of light-emitting materials which emits light of different colors can be used, whereby white light emission can also be obtained by expanding the width of the emission spectrum. Note that in order to obtain white light emission, light-emitting materials whose emission colors are complementary may be used. Specific examples of complementary colors include “blue and yellow” and “blue-green and red”.

### Application Example

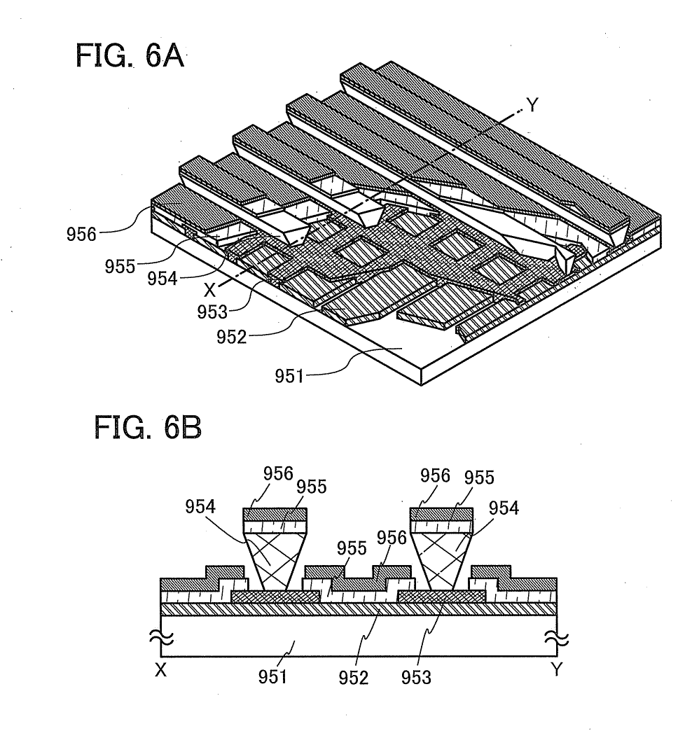

FIG. 6A is a perspective view of a passive matrix light-emitting device in which the above light-emitting elements are arranged in matrix. FIG. 6B is a cross-sectional view taken along a dashed line X-Y of FIG. 6A.

In FIGS. 6A and 6B, a layer 955 containing a light-emitting material is provided between an electrode 952 and an electrode 956, over a substrate 951. An end portion of the electrode 952 is covered with an insulating layer 953. A partition layer 954 is provided over the insulating layer 953. The partition layer 954 preferably has tapered sidewalls with such a slope that the distance between both sidewalls is gradually narrowed toward the surface of the substrate. That is, a cross section in a short side of the partition layer 954 is a trapezoidal shape, and a lower base (the side in contact with the insulating layer 953) is shorter than an upper base (the side not in contact with the insulating layer 953). By providing the partition layer 954 in this manner, defects in the light-emitting element due to static charge and the like can be prevented.

In the light-emitting device illustrated in FIGS. 6A and 6B, at least one of a plurality of light-emitting elements can be driven by the above method for driving a light-emitting element. Accordingly, deterioration in the light-emitting element can be suppressed and luminance of the light-emitting element can be recovered. In addition, a short circuit between the electrode 952 and the electrode 956 can be repaired by a simple method.

### Example 1

In this example, examples of a light-emitting device having a light-emitting element which is driven by the method for driving a light-emitting element of one embodiment of the present invention will be described.

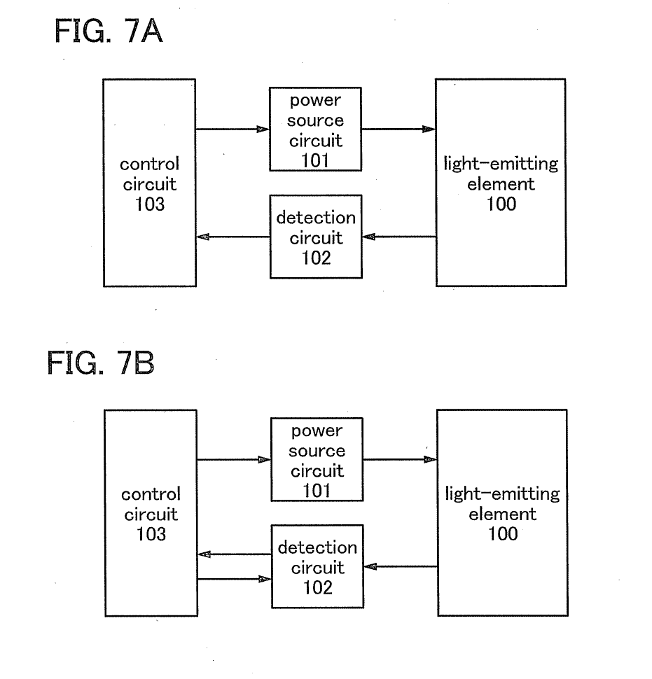

FIG. 7A is a block diagram illustrating a structural example of a light-emitting device. The light-emitting device illustrated in FIG. 7A includes a light-emitting element 100, a power source circuit 101 which can control a current passed through or a voltage applied to the light-emitting element 100, a detection circuit 102 which can detect a current passed through or a voltage applied to the light-emitting element 100, and a control circuit 103 which controls the operation of the power source circuit 101 in accordance with the information of a current or a voltage detected by the detection circuit 102.

In the light-emitting device illustrated in FIG. 7A, the operation of the power source circuit 101 is controlled in accordance with a current passed through or a voltage applied to the light-emitting element 100. That is, driving of the light-emitting element 100 by the power source circuit 101 can be selected as appropriate, depending on the state of the light-emitting element 100. Accordingly, a light-emitting device having a light-emitting element which is driven by the above method for driving a light-emitting element can be fabricated.

Further, as illustrated in FIG. 7B, a structure in which the operation of the detection circuit 102 is also controlled by the control circuit 103 can be employed. This enables the regular or irregular detection of a current passed through or a voltage applied to the light-emitting element 100 by the detection circuit 102.

### Example 2

In this example, examples of an electronic device provided with a light-emitting device having a light-emitting element which is driven by the method for driving a light-emitting element of one embodiment of the present invention will be described.

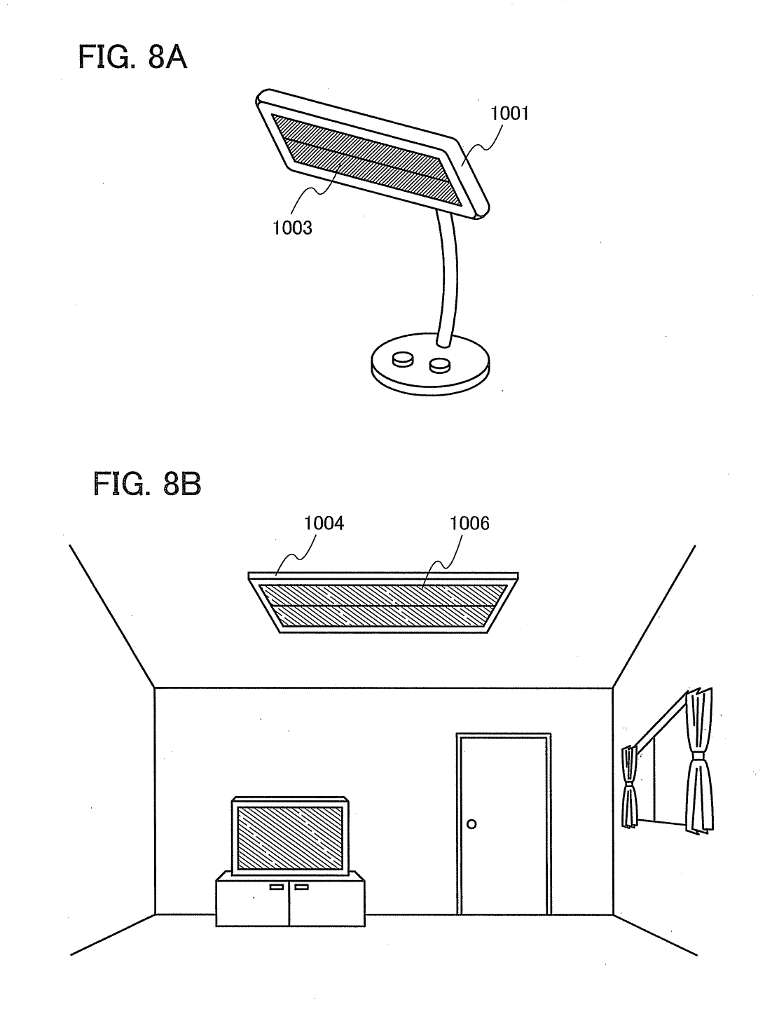

FIG. 8A is a view illustrating a desk lamp provided with the light-emitting device. The desk lamp includes a housing 1001 and a lighting portion 1003. The light-emitting device is used as the lighting portion 1003.

FIG. 8B is a view illustrating an indoor lighting device provided with the light-emitting device. The indoor lighting device includes a housing 1004 and a lighting portion 1006. The light-emitting device is used as the lighting portion 1006.

This application is based on Japanese Patent Application serial no. 2010-275926 filed with Japan Patent Office on Dec. 10, 2010, the entire contents of which are hereby incorporated by reference.

What is claimed is:

1. A method for driving a light-emitting element, in which the light-emitting element comprises a pair of electrodes and a layer containing a light-emitting material between the pair of electrodes, comprising:
a first step of passing a constant or substantially constant driving current through the light-emitting element; and
a second step of applying a bias voltage to the light-emitting element,
wherein the second step starts when a voltage applied to the light-emitting element in the first step is lower than or equal to an emission start voltage.

2. The method for driving a light-emitting element according to claim 1, wherein the bias voltage is applied to the light-emitting element in a forward direction in the second step.

3. The method for driving a light-emitting element according to claim 1, wherein the bias voltage is applied to the light-emitting element in a reverse direction in the second step.

4. The method for driving a light-emitting element according to claim 1, wherein the bias voltage is increased with time in the second step.

5. The method for driving a light-emitting element according to claim 1, wherein the first step starts following the second step when an absolute value of a current passed through the light-emitting element in the second step is decreased.

6. The method for driving a light-emitting element according to claim 1, wherein the voltage applied to the light-emitting element in the first step is measured constantly.

7. The method for driving a light-emitting element according to claim 1, wherein a current passed through the light-emitting element in the second step is measured constantly.

8. A method for driving a light-emitting element, in which the light-emitting element comprises a pair of electrodes and a layer containing a light-emitting material between the pair of electrodes, comprising the steps of:
applying a voltage between the pair of electrodes so that a constant or substantially constant driving current is passed through the light-emitting element; and
increasing an absolute value of the voltage applied between the pair of electrodes after the voltage is decreased to a level lower than or equal to an emission start voltage of the light-emitting element.

9. A method for driving a passive matrix light-emitting device, in which a plurality of light-emitting elements is arranged in matrix, comprising:
a first step of passing a constant or substantially constant driving current through a light-emitting element in the passive matrix light-emitting device; and
a second step of applying a bias voltage to the light-emitting element,
wherein the second step starts when a voltage applied to the light-emitting element in the first step is lower than or equal to an emission start voltage.

10. The method for driving a passive matrix light-emitting device according to claim 9, wherein the bias voltage is applied to the light-emitting element in a forward direction in the second step.

11. The method for driving a passive matrix light-emitting device according to claim 9, wherein the bias voltage is applied to the light-emitting element in a reverse direction in the second step.

12. The method for driving a passive matrix light-emitting device according to claim 9, wherein the bias voltage is increased with time in the second step.

13. The method for driving a passive matrix light-emitting device according to claim 9, wherein the first step starts following the second step when an absolute value of a current passed through the light-emitting element in the second step is decreased.

14. The method for driving a passive matrix light-emitting device according to claim 9, wherein the voltage applied to the light-emitting element in the first step is measured constantly.

15. The method for driving a passive matrix light-emitting device according to claim 9, wherein a current passed through the light-emitting element in the second step is measured constantly.
